(19) United States
(12) Patent Application Publication
(10) Pub. No.: US 2024/0340598 A1
(43) Pub. Date: Oct. 10, 2024

(54) MEMS STRUCTURE

(71) Applicant: Fortemedia, Inc., Alviso, CA (US)

(72) Inventors: Chun-Kai MAO, Tainan City (TW); Jien-Ming CHEN, Tainan City (TW); Wen-Shan LIN, Tainan City (TW); Nai-Hao KUO, Tainan City (TW)

(21) Appl. No.: 18/528,924

(22) Filed: Dec. 5, 2023

Related U.S. Application Data
(60) Provisional application No. 63/494,780, filed on Apr. 7, 2023.

(51) Int. Cl. H04R 19/04; H04R 1/08; H04R 7/02

(52) U.S. Cl. CPC H04R 19/04; H04R 1/08; H04R 7/02; H04R 2201/003

(57) ABSTRACT

A MEMS structure is provided. The MEMS structure includes a substrate having an opening portion and a backplate disposed on one side of the substrate. The backplate comprises a backplate conductive layer and a backplate insulating layer stacked with each other. The MEMS structure also includes a diaphragm disposed between the substrate and the backplate and extending across the opening portion of the substrate. The MEMS structure further includes a pillar structure connected with the backplate. The pillar structure comprises a pillar conductive layer and a pillar insulating layer stacked with each other.

### CROSS REFERENCE TO RELATED APPLICATIONS

This application claims the benefit of U.S. Provisional Application No. 63/494,780, filed on Apr. 7, 2023, the entirety of which is incorporated by reference herein.

### BACKGROUND OF THE INVENTION

### Field of the Invention

Embodiments of the present disclosure relate in general to an acoustic transducer, and in particular they relate to a micro-electro-mechanical system (MEMS) structure that may be used in a micro-electro-mechanical system microphone.

### Description of the Related Art

The current trend in personal electronics is toward fabricating slim, compact, lightweight and high-performance electronic devices, including microphones. A microphone is used to receive sound waves and convert acoustic signals into electrical signals. Microphones are widely used in daily life and are installed in such electronic products as telephones, mobiles phones, and recording pens. In a capacitive microphone, variations in acoustic pressure (i.e., local pressure deviation from the ambient atmospheric pressure caused by sound waves) force the diaphragm to deform correspondingly, and the deformation of the diaphragm changes the air gap, which induces a capacitance variation. The variation of acoustic pressure of the sound waves can thus be obtained by detecting the voltage difference caused by the capacitance variation.

This is distinct from conventional electret condenser microphones (ECM), in which mechanical and electronic elements of micro-electro-mechanical system (MEMS) microphones can be integrated on a semiconductor material using integrated circuit (IC) technology to fabricate a miniature microphone. MEMS microphones have such advantages as a compact size, being lightweight, and having low power consumption, and they have therefore entered the mainstream of miniaturized microphones.

Although existing MEMS microphones have generally been adequate for their intended purposes, they have not been entirely satisfactory in all respects. For example, the diaphragm of the MEMS microphone vibrates when acoustic pressure is applied, and it is deformed. During the air pressure, the diaphragm will suffer large deformation, which will cause crack in the sensor of the MEMS microphone.

### BRIEF SUMMARY OF THE INVENTION

The micro-electro-mechanical system (MEMS) structure in the present disclosure may be used in a micro-electro-mechanical system microphone, which includes a pillar structure is formed as a sandwich structure. In some embodiments, the pillar structure may reduce the deformation of the diaphragm, and may further reduce the stress concentration caused by the deformation of the diaphragm during the air pressure, thereby preventing the diaphragm from being damaged.

Some embodiments of the present disclosure include a MEMS structure. The MEMS structure includes a substrate having an opening portion and a backplate disposed on one side of the substrate. The backplate comprises a backplate conductive layer and a backplate insulating layer stacked with each other. The MEMS structure also includes a diaphragm disposed between the substrate and the backplate and extending across the opening portion of the substrate. The MEMS structure further includes a pillar structure connected with the backplate. The pillar structure comprises a pillar conductive layer and a pillar insulating layer stacked with each other.

In some embodiments, the pillar insulating layer is divided into a first pillar insulating layer and a second pillar insulating layer, and the pillar conductive layer is disposed between the first pillar insulating layer and the second pillar insulating layer.

In some embodiments, the backplate insulating layer is divided into a first backplate insulating layer and a second backplate insulating layer, and the backplate conductive layer is disposed between the first backplate insulating layer and the second backplate insulating layer.

In some embodiments, the first pillar insulating layer, the second pillar insulating layer, the first backplate insulating layer, and the second backplate insulating layer include the same material, while the pillar conductive layer and the backplate conductive layer include same material.

In some embodiments, in a top view, the pillar structure is formed as a complete or non-complete closed pattern.

In some embodiments, in a top view, the pillar structure is divided into a plurality of discontinuous segments.

In some embodiments, in a cross-sectional view, the pillar structure is formed in a concave shape.

In some embodiments, an air gap is formed between the diaphragm and the backplate, and the pillar structure extends from the backplate into the air gap.

In some embodiments, the pillar structure is separated from the diaphragm when there is no external force applied on the diaphragm.

In some embodiments, the backplate has acoustic holes, and in a top view, at least one of the acoustic holes is disposed inside the pillar structure.

In some embodiments, the MEMS structure further includes a protection post structure connected with the backplate. In a top view, the protection post structure surrounds the pillar structure.

In some embodiments, in the top view, the protection post structure is formed as a complete or non-complete closed pattern.

In some embodiments, the protection post structure is separated from the diaphragm when there is no external force applied on the diaphragm.

In some embodiments, the MEMS structure further includes a support post structure connected with the backplate. In the top view, the support post structure is disposed outside the protection post structure with respect to the pillar structure.

In some embodiments, the backplate has acoustic holes, and in the top view, at least one of the acoustic holes is disposed between the protection post structure and the support post structure.

Some embodiments of the present disclosure include a MEMS structure. The MEMS structure includes a substrate having an opening portion and a backplate disposed on one side of the substrate. The MEMS structure also includes a diaphragm disposed between the substrate and the backplate. The opening portion of the substrate is under the diaphragm, and an air gap is formed between the diaphragm and the backplate. The MEMS structure further includes a pillar structure connected with the backplate. The pillar structure is formed as a sandwich structure that comprises two insulating layers and a conductive layer between the insulating layers.

In some embodiments, the backplate is also formed as a sandwich structure that comprises two insulating layers and a conductive layer between the insulating layers.

### BRIEF DESCRIPTION OF THE DRAWINGS

Aspects of the embodiments of the present disclosure can be understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1A is a partial cross-sectional view illustrating a micro-electro-mechanical system (MEMS) structure according to some embodiments of the present disclosure.

FIG. 1B is a partial top view illustrating the backplate of the MEMS structure according to some embodiments of the present disclosure.

FIG. 2A is a partial cross-sectional view illustrating a micro-electro-mechanical system (MEMS) structure according to some other embodiments of the present disclosure.

FIG. 2B is a partial top view illustrating the backplate of the MEMS structure according to some other embodiments of the present disclosure.

FIG. 3A is a partial cross-sectional view illustrating a micro-electro-mechanical system (MEMS) structure according to some other embodiments of the present disclosure.

FIG. 3B is a partial top view illustrating the backplate of the MEMS structure according to some other embodiments of the present disclosure.

FIG. 4A is a partial cross-sectional view illustrating a micro-electro-mechanical system (MEMS) structure according to some other embodiments of the present disclosure.

FIG. 4B is a partial top view illustrating the backplate of the MEMS structure according to some other embodiments of the present disclosure.

FIG. 5A is a partial cross-sectional view illustrating a micro-electro-mechanical system (MEMS) structure according to some other embodiments of the present disclosure.

FIG. 5B is a partial top view illustrating the backplate of the MEMS structure according to some other embodiments of the present disclosure.

### DETAILED DESCRIPTION OF THE INVENTION

The following disclosure provides many different embodiments, or examples, for implementing different features of the subject matter provided. Specific examples of components and arrangements are described below to simplify the present disclosure. These are, of course, merely examples and are not intended to be limiting. For example, a first feature is formed on a second feature in the description that follows may include embodiments in which the first feature and second feature are formed in direct contact, and may also include embodiments in which additional features may be formed between the first feature and second feature, so that the first feature and second feature may not be in direct contact. In addition, the present disclosure may repeat reference numerals and/or letters in the various examples. This repetition is for the purpose of simplicity and clarity and does not in itself dictate a relationship between the various embodiments and/or configurations discussed.

It should be understood that additional steps may be implemented before, during, or after the illustrated methods, and some steps might be replaced or omitted in other embodiments of the illustrated methods.

Furthermore, spatially relative terms, such as “beneath,” “below,” “lower,” “on,” “above,” “upper” and the like, may be used herein for ease of description to describe one element or feature's relationship to other elements or features as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In the present disclosure, the terms “about,” “approximately” and “substantially” typically mean +/−20% of the stated value, more typically +/−10% of the stated value, more typically +/−5% of the stated value, more typically +/−3% of the stated value, more typically +/−2% of the stated value, more typically +/−1% of the stated value and even more typically +/−0.5% of the stated value. The stated value of the present disclosure is an approximate value. That is, when there is no specific description of the terms “about,” “approximately” and “substantially”, the stated value includes the meaning of “about,” “approximately” or “substantially”.

Unless otherwise defined, all terms (including technical and scientific terms) used herein have the same meaning as commonly understood by one of ordinary skill in the art to which this disclosure belongs. It should be understood that terms such as those defined in commonly used dictionaries should be interpreted as having a meaning that is consistent with their meaning in the context of the relevant art and will not be interpreted in an idealized or overly formal sense unless expressly so defined in the embodiments of the present disclosure.

The present disclosure may repeat reference numerals and/or letters in following embodiments. This repetition is for the purpose of simplicity and clarity and does not in itself dictate a relationship between the various embodiments and/or configurations discussed.

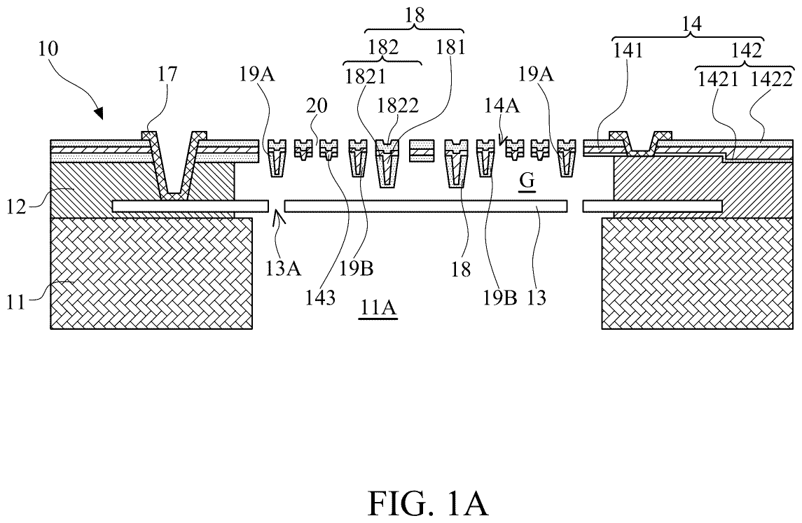

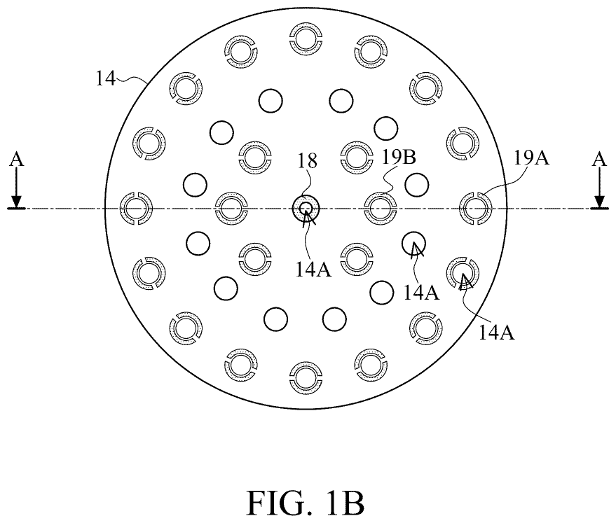

FIG. 1A is a partial cross-sectional view illustrating a micro-electro-mechanical system (MEMS) structure 10 according to some embodiments of the present disclosure. For example, the MEMS structure 10 may be a capacitive microphone. As shown in FIG. 1A, in some embodiments, the MEMS structure 10 includes a substrate 11, a dielectric layer 12, a diaphragm 13, a backplate 14, and an electrode layer 17. It should be noted that some components of the MEMS structure 10 have been omitted in FIG. 1A for sake of brevity.

The substrate 11 is configured to support the dielectric layer 12, the diaphragm 13, a backplate 14, and an electrode layer 17 on one side of the substrate 11. As shown in FIG. 1A, in some embodiments, the substrate 11 has an opening portion 11A. The opening portion 11A allows sound waves received by the MEMS structure 10 (e.g., MEMS microphone) to pass through and/or enter the MEMS structure 10. For example, the substrate 11 may include silicon or the like, but the present disclosure is not limited thereto.

The dielectric layer 12 is disposed between the substrate 11 and the diaphragm 13, and between the diaphragm 13 and the backplate 14. In other words, the diaphragm 13 is inserted in the dielectric layer 12, so as to provide partial isolation between the substrate 11, the diaphragm 13 and, the backplate 14 from each other. Moreover, the dielectric layer 12 is disposed around the diaphragm 13 and the backplate 14, so that the diaphragm 13 and the backplate 14 are supported at their edges by the dielectric layer 12. The dielectric layer 12 may include and oxide, such as silicon oxide or the like, but the present disclosure is not limited thereto.

The backplate 14 is disposed on one side of the substrate 11. The backplate 14 may have sufficient stiffness, so that it would not be bending or movable when the sound waves pass through the backplate 14. For example, the backplate 14 may be a stiff perforated element, but the present disclosure is not limited thereto. As shown in FIG. 1A, in some embodiments, the backplate 14 has a number of acoustic holes 14A, and each acoustic hole 14A passes through the backplate 14. The acoustic holes 14A are configured to allow the sound waves to pass through.

As shown in FIG. 1A, in some embodiments, the backplate 14 is formed as a sandwich structure that includes two insulating layers and a conductive layer between the insulating layers. In this embodiment, the backplate 14 includes a backplate conductive layer 141 and a backplate insulating layer 142 stacked with each other. In more detail, the backplate insulating layer 142 has (or is divided into) a first backplate insulating layer 1421 and a second backplate insulating layer 1422, and the backplate conductive layer 141 is disposed between the first backplate insulating layer 1421 and the second backplate insulating layer 1422.

For example, the backplate conductive layer 141 may include poly-silicon or the like, and the backplate insulating layer 142 (e.g., the first backplate insulating layer 1421 and the second backplate insulating layer 1422) may include a nitride, such as silicon nitride or the like, but the present disclosure is not limited thereto. Moreover, the first backplate insulating layer 1421 and the second backplate insulating layer 1422 may include the same material or different materials.

As shown in FIG. 1A, in some embodiments, the backplate conductive layer 141 is divided into a plurality of conductive segments that are disconnected with each other in a cross-sectional view of the backplate 14, but the present disclosure is not limited thereto. In some other embodiments, the backplate conductive layer 141 is a (complete) conductive segment.

The MEMS structure 10 may be electrically connected to a circuit (not shown) via several electrode pads of the electrode layer 17 that is disposed on the backplate 14 and electrically connected to the backplate conductive layer 141 and the diaphragm 13. For example, the electrode layer 17 may include copper, silver, gold, aluminum, the like, alloy thereof, or a combination thereof, but the present disclosure is not limited thereto.

The diaphragm 13 is disposed between the substrate 11 and the backplate 14, and the opening portion 11A of the substrate 11 is under the diaphragm 13. The diaphragm 13 is movable or displaceable relative to the backplate 14. The diaphragm 13 is configured to sense the sound waves received by the MEMS structure 10 (e.g., MEMS microphone). As shown in FIG. 1A, in some embodiments, the diaphragm 13 includes ventilation holes 13A, and an air gap G is formed between the diaphragm 13 and the backplate 14. The sound waves pass through the diaphragm 13 via ventilation holes 13A to reach the air gap G, and then pass through the backplate 14 via acoustic holes 14A.

In more detail, the displacement change of the diaphragm 13 relative to the backplate 14 causes a capacitance change between the diaphragm 13 and the backplate 14. The capacitance change is then converted into an electric signal by circuitry connected with the diaphragm 13 and the backplate 14, and the electrical signal is sent out of the MEMS structure 10 through the electrode layer 17.

On the other hand, in order to increase the sensitivity of the diaphragm 13, a number of ventilation holes 13A may be provided in the diaphragm 13 to reduce the stiffness of the diaphragm 13. In some embodiments, there may be more than two ventilation holes 13A. With this structural feature, high sensitivity of the MEMS structure 10 may be achieved. In addition, the ventilation holes 13A in the diaphragm 13 are also configured to relieve the high air pressure on the diaphragm 13.

As shown in FIG. 1A, in some embodiments, the MEMS structure 10 includes a pillar structure 18 connected with the backplate 14. Moreover, in some embodiment, the pillar structure 18 extends from the backplate 14 into the air gap G, and the pillar structure 18 is separated from the diaphragm 13 when there is no external force applied on the diaphragm 13.

The pillar structure 18 may be formed simultaneously with the backplate 14 using the same processes. As shown in FIG. 1A, in some embodiments, the pillar structure 18 is formed as a sandwich structure that includes two insulating layers and a conductive layer between the insulating layers. In this embodiment, the pillar structure 18 includes a pillar conductive layer 181 and a pillar insulating layer 182 stacked with each other. In more detail, the pillar insulating layer 182 has (or is divided into) a first pillar insulating layer 1821 and a second pillar insulating layer 1822, and the pillar conductive layer 181 is disposed between the first pillar insulating layer 1821 and the second pillar insulating layer 1822.

In some embodiments, since the pillar structure 18 may be formed simultaneously with the backplate 14 using the same processes, the first pillar insulating layer 1821, the second pillar insulating layer 1822, the first backplate insulating layer 1421, and the second backplate insulating layer 1422 include the same material, and the pillar conductive layer 181 and the backplate conductive layer 141 include same material. However, the present disclosure is not limited thereto.

As shown in FIG. 1A, in some embodiments, the MEMS structure 10 further includes a protection post structure 19B connected with the backplate. In more detail, the protection post structure 19B extends from the backplate 14 into the air gap G. Similarly, in some embodiments, the protection post structure 19B is separated from the diaphragm 14 when there is no external force applied on the diaphragm 14. For example, the protection post structure 19B may include a conductive material (e.g., semiconductor material such as silicon (Si) or germanium (Ge)) or an insulating material (e.g., silicon nitride).

In this embodiments, the protection post structure 19B is also formed as a sandwich structure and may be formed simultaneously with the backplate 14 and the pillar structure 18 using the same processes, but the present disclosure is not limited thereto. In some other embodiments, the protection post structure 19B may be the entire insulating pillar or the entire conductive pillar, which may be adjusted according to actual needs.

In some embodiments, the MEMS structure 10 further includes a support post structure 19A connected with the backplate. In more detail, the support post structure 19A extends from the backplate 14 into the air gap G. Similarly, in some embodiments, the support post structure 19A is separated from the diaphragm 14 when there is no external force applied on the diaphragm 14. The support post structure 19A may include the same material or similar material to the protection post structure 19B.

In this embodiments, the support post structure 19A is also formed as a sandwich structure and may be formed simultaneously with the backplate 14, the pillar structure 18, and the protection post structure 19B using the same processes, but the present disclosure is not limited thereto. In some other embodiments, the protection post structure 19B may be the entire insulating pillar or the entire conductive pillar, which may be adjusted according to actual needs.

FIG. 1B is a partial top view illustrating the backplate 14 of the MEMS structure 10 according to some embodiments of the present disclosure, which may show the relationship between the acoustic holes 14A, the pillar structure 18, the protection post structure 19B, and the support post structure 19A. For example, FIG. 1A may be a cross-sectional view of the MEMS structure 10 along line A-A in FIG. 1B, but the present disclosure is not limited thereto. It should be noted that FIG. 1B may not correspond exactly to FIG. 1A, and some components have been omitted in FIG. 1B for sake of brevity.

As shown in FIG. 1B, in this embodiment, in a top view (e.g., the top view shown in FIG. 1B), the pillar structure 18 is formed as a complete closed pattern. In more detail, the pillar structure 18 is formed as a ring or a circle, but the present disclosure is not limited thereto. Furthermore, in this embodiment, in the top view, at least one acoustic hole 14A is disposed inside the pillar structure 18 (i.e., inside the complete closed pattern).

As shown in FIG. 1B, in this embodiment, in the top view (e.g., the top view shown in FIG. 1B), there is a number of protection post structures 19B, and the protection post structures 19B surround the pillar structure 18. Moreover, in the top view, there is a number of support post structures 19A, and the support post structures 19A are disposed outside the protection post structure 19B with respect to the pillar structure 18. Furthermore, in some embodiments, in the top view, at least one acoustic hole 14A is disposed between the protection post structure 19B and the support post structure 19A.

Similarly, in the top view, the protection post structure 19B is formed as a complete closed pattern, and the support post structure 19A is formed as a complete closed pattern, but the present disclosure is not limited thereto. In some other embodiments, in the top view, each of the pillar structure 18, the protection post structure 19B, and the support post structure 19A is formed as a non-complete closed pattern.

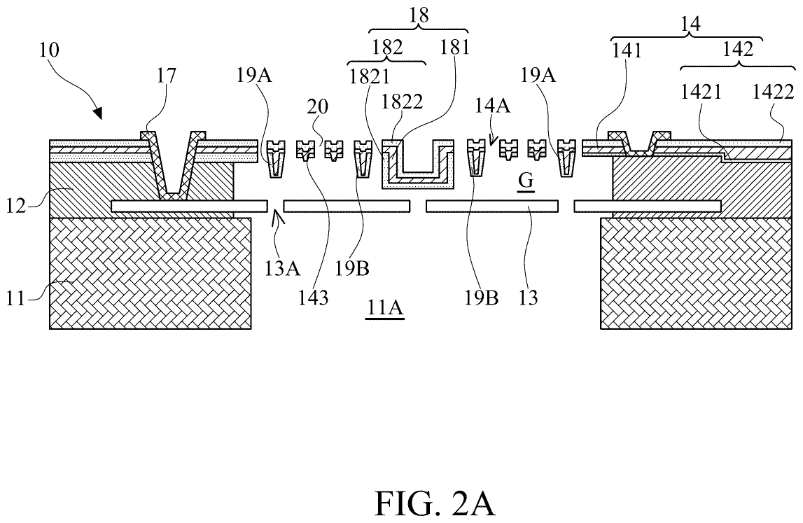

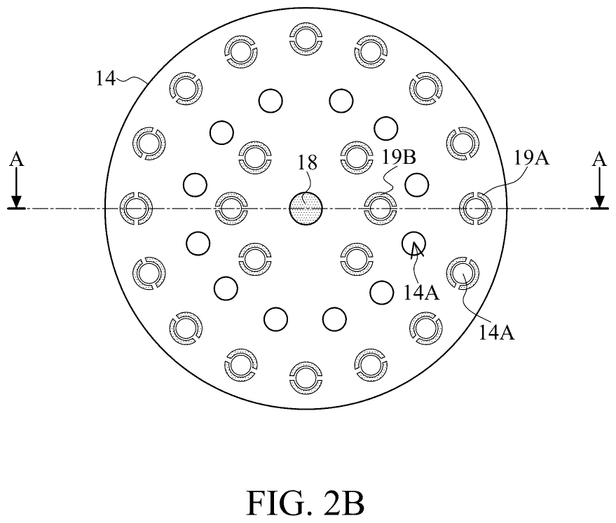

FIG. 2A is a partial cross-sectional view illustrating a micro-electro-mechanical system (MEMS) structure 10 according to some other embodiments of the present disclosure. FIG. 2B is a partial top view illustrating the backplate 14 of the MEMS structure 10 according to some other embodiments of the present disclosure, which may show the relationship between the acoustic holes 14A, the pillar structure 18, the protection post structure 19B, and the support post structure 19A. For example, FIG. 2A may be a cross-sectional view of the MEMS structure 10 along line A-A in FIG. BB, but the present disclosure is not limited thereto. It should be noted that FIG. 2B may not correspond exactly to FIG. 1A, and some components have been omitted in FIG. 2B for sake of brevity.

As shown in FIG. 2A and FIG. 2B, in some embodiments, the pillar structure 18 corresponds to the center of the backplate 14 and the center of the diaphragm 13. That is, the pillar structure 16 may be connected to the center of the backplate 14 and extend towards the center of the diaphragm 13, but the present disclosure is not limited thereto. Moreover, in this embodiment, in a cross-sectional view (e.g., the cross-sectional view shown in FIG. 2A), the pillar structure 18 is formed in a concave shape or a hollow shape. That is, there is a space inside the pillar structure 18, but the present disclosure is not limited thereto. In some other embodiments, the pillar structure 18 is a solid structure.

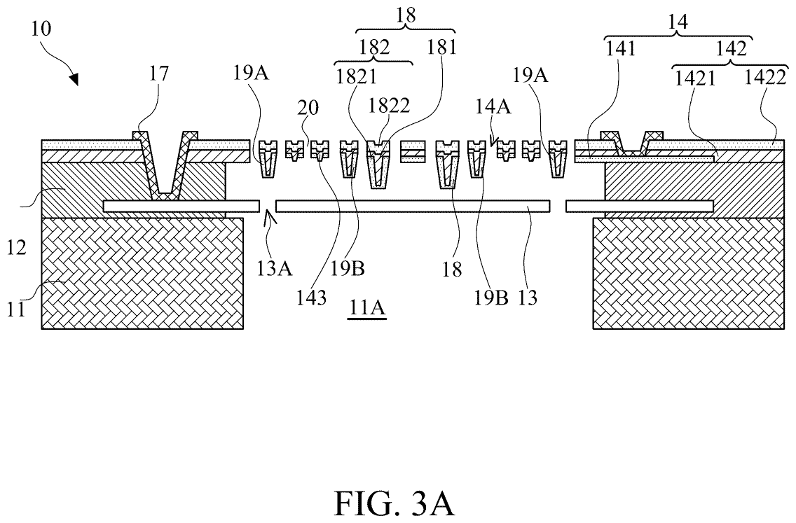

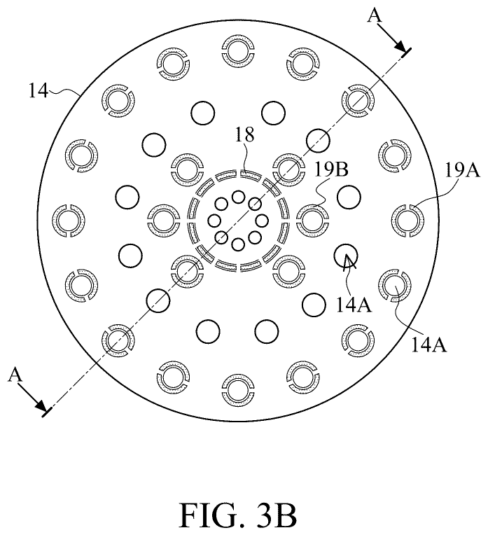

FIG. 3A is a partial cross-sectional view illustrating a micro-electro-mechanical system (MEMS) structure 10 according to some other embodiments of the present disclosure. FIG. 3B is a partial top view illustrating the backplate 14 of the MEMS structure 10 according to some other embodiments of the present disclosure, which may show the relationship between the acoustic holes 14A, the pillar structure 18, the protection post structure 19B, and the support post structure 19A. For example, FIG. 3A may be a cross-sectional view of the MEMS structure 10 along line A-A in FIG. BB, but the present disclosure is not limited thereto. It should be noted that FIG. 3B may not correspond exactly to FIG. 1A, and some components have been omitted in FIG. 3B for sake of brevity.

As shown in FIG. 3B, in some embodiments, in the top view, the pillar structure 18 is divided into a plurality of discontinuous segments. In more detail, the pillar structure is formed as a non-complete closed pattern, such as a discontinuous ring or circle. Furthermore, in this embodiment, in the top view, there are more than two acoustic holes 14A disposed inside the pillar structure 18 (i.e., inside the non-complete closed pattern).

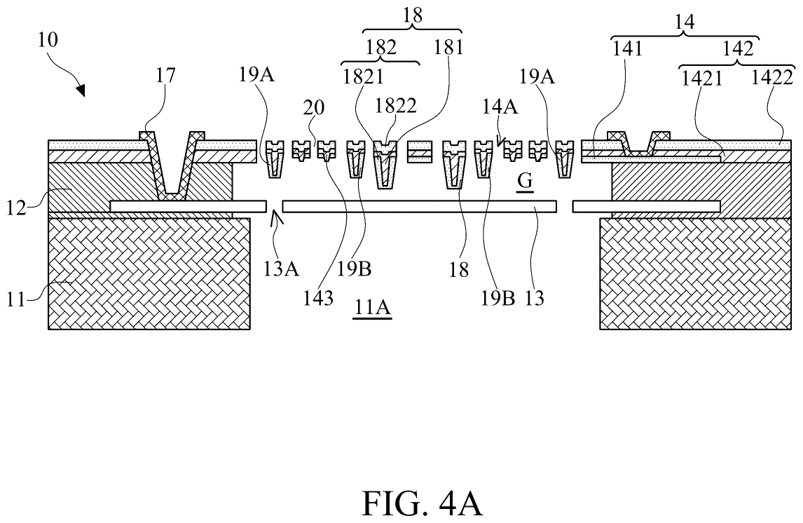

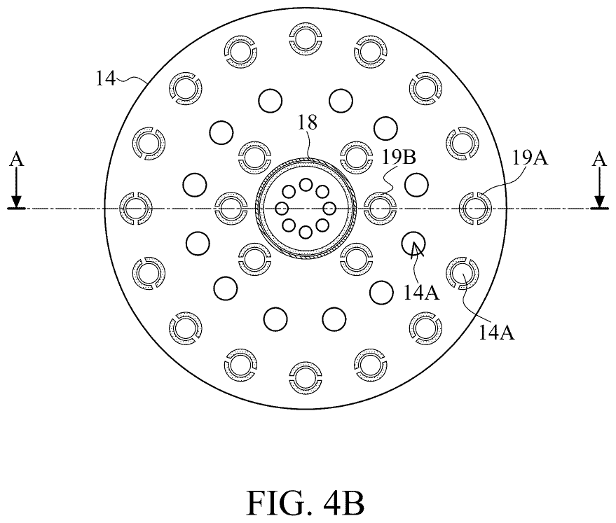

FIG. 4A is a partial cross-sectional view illustrating a micro-electro-mechanical system (MEMS) structure 10 according to some other embodiments of the present disclosure. FIG. 4B is a partial top view illustrating the backplate 14 of the MEMS structure 10 according to some other embodiments of the present disclosure, which may show the relationship between the acoustic holes 14A, the pillar structure 18, the protection post structure 19B, and the support post structure 19A. For example, FIG. 4A may be a cross-sectional view of the MEMS structure 10 along line A-A in FIG. BB, but the present disclosure is not limited thereto. It should be noted that FIG. 4B may not correspond exactly to FIG. 1A, and some components have been omitted in FIG. 4B for sake of brevity.

As shown in FIG. 4B, in some embodiments, in the top view, the pillar structure 18 is formed as a complete closed pattern. In more detail, the pillar structure 18 is formed as a ring or a circle, but the present disclosure is not limited thereto. Furthermore, in this embodiment, in the top view, there are more than two acoustic holes 14A disposed inside the pillar structure 18 (i.e., inside the complete closed pattern).

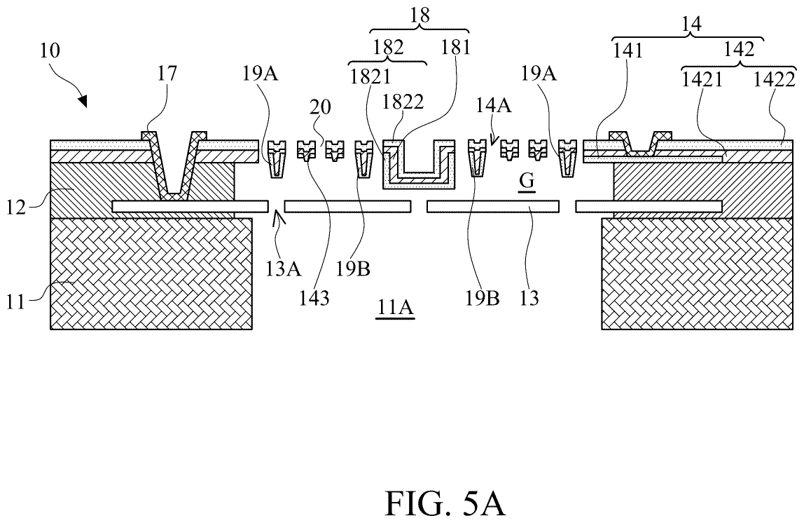

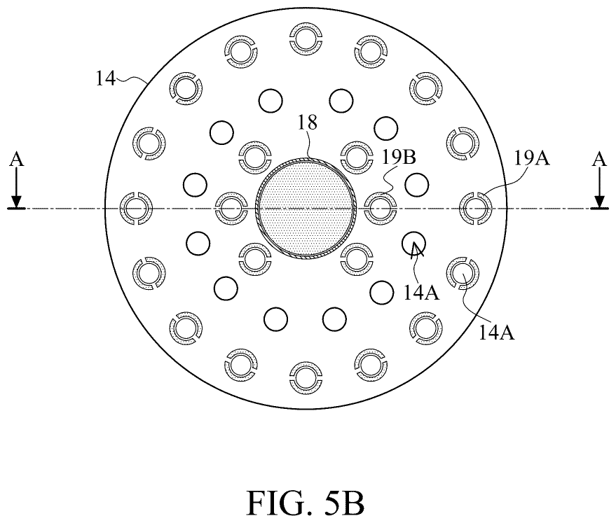

FIG. 5A is a partial cross-sectional view illustrating a micro-electro-mechanical system (MEMS) structure 10 according to some other embodiments of the present disclosure. FIG. 5B is a partial top view illustrating the backplate 14 of the MEMS structure 10 according to some other embodiments of the present disclosure, which may show the relationship between the acoustic holes 14A, the pillar structure 18, the protection post structure 19B, and the support post structure 19A. For example, FIG. 5A may be a cross-sectional view of the MEMS structure 10 along line A-A in FIG. BB, but the present disclosure is not limited thereto. It should be noted that FIG. 5B may not correspond exactly to FIG. 1A, and some components have been omitted in FIG. 5B for sake of brevity.

As shown in FIG. 5A and FIG. 5B, in some embodiments, the pillar structure 18 corresponds to the center of the backplate 14 and the center of the diaphragm 13. That is, the pillar structure 16 may be connected to the center of the backplate 14 and extend towards the center of the diaphragm 13, but the present disclosure is not limited thereto. Moreover, in this embodiment, in a cross-sectional view (e.g., the cross-sectional view shown in FIG. 5A), the pillar structure 18 is formed in a concave shape or a hollow shape. That is, there is a space inside the pillar structure 18, but the present disclosure is not limited thereto. In some other embodiments, the pillar structure 18 is a solid structure.

As noted above, in the embodiments of the present disclosure, since the MEMS structure includes a pillar structure that is formed as a sandwich structure, thereby reducing the stress concentration caused by the deformation of the diaphragm during the air pressure and preventing the diaphragm from being damaged.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. Therefore, the scope of protection should be determined through the claims. In addition, although some embodiments of the present disclosure are disclosed above, they are not intended to limit the scope of the present disclosure.

Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Thus, discussions of the features and advantages, and similar language, throughout this specification may, but do not necessarily, refer to the same embodiment.

Furthermore, the described features, advantages, and characteristics of the disclosure may be combined in any suitable manner in one or more embodiments. One skilled in the relevant art will recognize, in light of the description provided herein, that the disclosure can be practiced without one or more of the specific features or advantages of a particular embodiment. In other instances, additional features and advantages may be recognized in certain embodiments that may not be present in all embodiments of the disclosure.

What is claimed is:

1. A micro-electro-mechanical system structure, comprising:
a substrate having an opening portion;
a backplate disposed on one side of the substrate, wherein the backplate comprises a backplate conductive layer and a backplate insulating layer stacked with each other;
a diaphragm disposed between the substrate and the backplate and extending across the opening portion of the substrate;
a pillar structure connected with the backplate, wherein the pillar structure comprises a pillar conductive layer and a pillar insulating layer stacked with each other.

2. The micro-electro-mechanical system structure as claimed in claim 1, wherein the pillar insulating layer is divided into a first pillar insulating layer and a second pillar insulating layer, and the pillar conductive layer is disposed between the first pillar insulating layer and the second pillar insulating layer.

3. The micro-electro-mechanical system structure as claimed in claim 2, wherein the backplate insulating layer is divided into a first backplate insulating layer and a second backplate insulating layer, and the backplate conductive layer is disposed between the first backplate insulating layer and the second backplate insulating layer.

4. The micro-electro-mechanical system structure as claimed in claim 3, wherein the first pillar insulating layer, the second pillar insulating layer, the first backplate insulating layer, and the second backplate insulating layer comprise the same material, while the pillar conductive layer and the backplate conductive layer comprise same material.

5. The micro-electro-mechanical system structure as claimed in claim 1, wherein in a top view, the pillar structure is formed as a complete or non-complete closed pattern.

6. The micro-electro-mechanical system structure as claimed in claim 1, wherein in a top view, the pillar structure is divided into a plurality of discontinuous segments.

7. The micro-electro-mechanical system structure as claimed in claim 1, wherein in a cross-sectional view, the pillar structure is formed in a concave shape.

8. The micro-electro-mechanical system structure as claimed in claim 1, wherein an air gap is formed between the diaphragm and the backplate, and the pillar structure extends from the backplate into the air gap.

9. The micro-electro-mechanical system structure as claimed in claim 1, wherein the pillar structure is separated from the diaphragm when there is no external force applied on the diaphragm.

10. The micro-electro-mechanical system structure as claimed in claim 1, wherein the backplate has acoustic holes, and in a top view, at least one of the acoustic holes is disposed inside the pillar structure.

11. The micro-electro-mechanical system structure as claimed in claim 1, further comprising:
a protection post structure connected with the backplate, wherein in a top view, the protection post structure surrounds the pillar structure.

12. The micro-electro-mechanical system structure as claimed in claim 11, wherein in the top view, the protection post structure is formed as a complete or non-complete closed pattern.

13. The micro-electro-mechanical system structure as claimed in claim 11, wherein the protection post structure is separated from the diaphragm when there is no external force applied on the diaphragm.

14. The micro-electro-mechanical system structure as claimed in claim 11, further comprising:
a support post structure connected with the backplate, wherein in the top view, the support post structure is disposed outside the protection post structure with respect to the pillar structure.

15. The micro-electro-mechanical system structure as claimed in claim 11, wherein the backplate has acoustic holes, and in the top view, at least one of the acoustic holes is disposed between the protection post structure and the support post structure.

16. A micro-electro-mechanical system structure, comprising:
a substrate having an opening portion;
a backplate disposed on one side of the substrate;
a diaphragm disposed between the substrate and the backplate, wherein the opening portion of the substrate is under the diaphragm, and an air gap is formed between the diaphragm and the backplate;
a pillar structure connected with the backplate, wherein the pillar structure is formed as a sandwich structure that comprises two insulating layers and a conductive layer between the insulating layers.

17. The micro-electro-mechanical system structure as claimed in claim 16, wherein the backplate is also formed as a sandwich structure that comprises two insulating layers and a conductive layer between the insulating layers.
